(19) United States
(12) Patent Application Publication
(10) Pub. No.: US 2024/0401569 A1
(43) Pub. Date: Dec. 5, 2024

(54) METHOD FOR HARVESTING OVERHEAD WIND ENERGY

(71) Applicants: Huy Toan VU, Hanoi (VN); CONSTRUCTION MACHINERY AND INDUSTRIAL WORKS CONINCO JOINT STOCK COMPANY, Hanoi (VN)

(72) Inventors: Huy Toan VU, Hanoi (VN); Minh Tuan CAO, Hanoi (VN); Van Thong NGUYEN, Hanoi (VN)

(73) Assignees: Huy Toan VU, Hanoi (VN); CONSTRUCTION MACHINERY AND INDUSTRIAL WORKS CONINCO JOINT STOCK COMPANY, Hanoi (VN)

(21) Appl. No.: 18/697,430

(22) PCT Filed: Sep. 28, 2022
(86) PCT No.: PCT/VN2022/000009

§ 371 Date: Mar. 29, 2024

(30) Foreign Application Priority Data
Oct. 4, 2021 (VN) 1-2021-06170

(51) Int. Cl. F03D 9/35; F03D 1/04; F03D 3/04

(52) U.S. Cl. CPC F03D 9/35; F03D 1/041; F03D 3/0427; F05B 2240/131; F05B 2250/323

(57) ABSTRACT

The invention relates to a method of harvesting overhead wind energy with greater efficiency and being better in terms of manufacturing technology and equipment installation. In particular, the invention relates to a method of harvesting overhead wind energy with an equipment system for indirectly catching wind, the method comprises:
catching overhead wind;
guiding the caught overhead wind downwards;
converting the energy of the caught wind into mechanical work to rotate one or more generators on the ground.

The cost of the equipment system for indirectly catching wind is much cheaper than those of the traditional wind electricity pylon.

### TECHNICAL FIELD OF THE INVENTION

The invention relates to the field of converting wind energy into rotational mechanical energy or electrical energy to serve the needs of civil life, production activities, and so on. More specifically, the present invention relates to a method for harvesting energy of the overhead wind which has greater and more stable velocity than those of the ground wind which is affected by a variety of terrain factors at different altitudes.

### TECHNICAL BACKGROUND

Except being used for sailing ships, wind energy in general has been used by mankind from time immemorial all through wind engines, also known as wind turbines. Depending on whether the rotation axis is vertically or horizontally placed, wind turbines are divided into the vertical axis type and the horizontal axis type. No matter which type is used, on the whole there has been only one solution so far, according to which the wind turbines with the blades thereof are directly placed into the moving airflow. It is known that the velocity of the overhead wind is always larger and more stable than those of the ground wind, while the wind blowing directly to the wind turbine has the power P_{G} which is proportional to the cube of the wind velocity (V):

$${P}_{G} = 0.5 ρ {SV}^{3} \qquad ( 1 )$$

where ρ is the air density; S is the wind-catch area of the blade's sweeping range. Therefore, raising the wind turbine up high to utilize the most of wind energy was the first solution being thought of when developing the wind electricity industry and has been used hitherto.

However, raising the wind turbine up high is only suitable for horizontal axis wind engines because the said engines can work with high velocity winds while maintaining the ability to withstand thunderstorms. In order to work with the high wind velocity, which also means working with the high wind pressure, the wind-catch cross section (s) of the blades must be reduced, otherwise the blades will be easily broken. But, in such case, there is a decrease in the static wind-catch coefficient (kₜ) which is the ratio of the wind-catch cross section (s) of the n blades to the circular surface area (S) swept by the blades:

$${k}_{t} = \frac{ns}{S} \qquad ( 2 )$$

Of course, the static wind-catch coefficient here only takes into account the blade's capacity of absorbing the wind energy which has not yet been converted into the mechanical work to turn the wind engine. An increase in the static wind-catch coefficient kₜ does not mean a linear increase in the absorption power of the wind engine because there is a mutual influence between the blades. In fact, only 3 blades should be selected (see the reference 1). Moreover, it is known that for the blades, not only the wind pressure mentioned above, but also a pressure difference due to the difference in the flow rates between the blade's front side which directly catches the wind and the blade's back side which withstands the eddies characterized by the aerodynamic coefficient k_{d}, would depend on the wind velocity and the specific geometry of the blade. Actual measurements show:

$${k}_{d} = ( 2.5 \div 3.5 ) {k}_{t} \qquad ( 3 )$$

It is known that the calculation of wind engine efficiency so far has been mainly based on Betz's law, which was proved at the beginning of the twentieth century with the aim of finding an upper limit for the energy harvesting efficiency of the wind engine's blades while no attention was paid to the fact whether the obtained energy could be converted into the mechanical work to rotate that blades (see the reference 2); the said limit according to Betz's calculation is <59.3%. The state assessment for the existing wind engines should be resumed right from Betz's law as presented in the reference 3, according to which the actual efficiency of the wind engines is not as great as 30-45% as expected so far.

In practical terms, the inventors performed tests on wind engines under the actual operation (see FIG. 1) and found that the static wind-catch coefficient kₜ of the blades according to (2) is only ˜3.8% and the dynamic wind-catch coefficient k_{d} according to (3) can be greater than 2.5÷3.5 times, depending on the wind velocity. Therefore, the actual efficiency of the blade must definitely be less than and cannot exceed 10%, because of the loss during the conversion from the wind energy into the mechanical work to rotate the blades (see FIG. 2).

Meanwhile, arranging equipments at the high altitudes with high wind velocities helps to obtain large wind energy, but also requires complex technical solutions in manufacturing as well as in transportation, installation, operation and maintenance with costly expenses. For example, a 10 MW wind engine has a support pylon up to 240 m high and 3 blades, each weighing 30÷50 tons and having a length of over 100 m. Further, the entire cluster of generators weighing hundreds of tons is also arranged on top of that support pylon. Such facts show how difficult such arrangement is. Therefore, the investment rate for overhead wind electricity is even greater than those for hydroelectricity, in particular the former may take about 1.5 millions USD/MW, even more expensive than those for low power wind engines placed at the lower altitudes but with large numbers to have the same total power.

In addition, it is inevitable to have a noise pollution caused by the blades with large wingspan, in particular the aerodynamic noise generated during the interaction of the blades with the airflow. The noise level of the wind engine at the 350 m distance is 35÷45 dBs; near the blade axis of a high power wind engine, the noise level can exceed 100 dBs. In addition, broken or expired blades will also be a big problem in recycling the non-disintegrable fiberglass composite waste as such. In other words, improving the efficiency of wind energy harvesting methods has become an urgent demand on a global scale.

The foregoing poses challenges for the long-term development of wind energy when overhead wind engines account for an increasingly large proportion, up to 20÷30%, in the electricity structure of the grid in the national level in particular, and in the global level in general. Recently, there have been known solutions of splitting the wind-catch area so that it is possible to use much shorter blades, installed on the same array with height up to 300 m. However, in practical terms, it is not feasible to adjust such a large array in the direction of the airflow.

### REFERENCES

1—Nguyen Ngoc Tan, Wind electricity industry, Ho Chi Minh city, 2012. https://tailieu.vn/docview/tailieu/2015/20151016/nhasinhaoanh_08/c3_c ong_nghiep_dien_gio_2012_do_ngoc_tan_6866.pdf?rand=813561
2—Betz's Law, https://en.wikipedia.org/wiki/Betz %27s_law
3—Vu Huy Toan, Re-calculating the wind engine efficiency, reported at the 7th National Conference on Engineering and Applied Physics CAEP 7, 2021.

### SUMMARY OF THE INVENTION

The purpose of the present invention is to overcome the disadvantages mentioned in the prior art. The present invention relates to a method of harvesting overhead wind energy with an equipment system for indirectly catching wind, the method comprises:
catching overhead wind;
guiding the caught overhead wind downwards;
converting the energy of the caught wind into mechanical work to rotate one or more generators,
wherein the equipment system for indirectly catching wind comprises:
   an overhead wind catcher with a flare inlet and a narrow outlet to increase the velocity of the wind caught and guided downwards;
   a tail vane attached to the overhead wind catcher to orientate the latter towards the wind direction;
   a windbreak cover;
   a wind duct to guide the caught wind downwards;
a high efficiency air turbine;
optionally an air exit chamber; and an operation station on the ground to encompass all parts of the wind engine and other auxiliary structures;
   characterized in that:
   the blade's wind-catch efficiency η_{CQ} of the wind engine is determined on the basis of the wind component that can bring the rotation mechanical energy to the blade, not on the basis of the total wind absorbed by the blade like Betz's method; this efficiency is not a fixed number for every blade but depends on a specific blade type and the most important thing is that this efficiency is actually very low, ˜10 times smaller than those according to the Betz limit and ˜6÷9 times smaller than those announced by wind engine manufacturers;
because of such very low efficiency of the wind engine arranged at high altitudes, instead of using the said wind engine with large cross section S of the blade's wind-catch circular surface, only a much smaller and lighter wind catcher can be used, the wind is guided downwards by the wind duct to the wind engine and the generator assembly which are arranged on independent structures on the ground and work with the caught wind which is completely oriented.

The method according to the invention has the following advantages:

Firstly, because the entire wind engine and generator are located on the ground, and the wind is guided downwards, the support pylon has to support the wind catcher only and simultaneously acts as a wind duct, so it will have to bear a wind catcher load only and therefore has the dimension much smaller than those of currently known wind turbine towers, eliminating the high requirements on the supporting structure, while the power of the wind engine remains unchanged.

Secondly, because no overhead blade is required, the problem with super-long and super-weight components is no longer present and the distance between wind electricity pylons will also be significantly reduced, facilitating the construction of wind electricity farms with a construction density tens of times greater than those for current overhead wind engines.

Third, the cost of manufacturing, transporting and installing wind engine is significantly reduced, at least not less than 3 times.

Fourth, because the gravity center of the entire wind turbine system structure has been greatly lowered, there is an increase in the ability to withstand earthquakes.

Fifth, because the wind spreading at high altitudes is no longer an issue, as now the wind is oriented into a certain flow, applying methods of converting wind energy into mechanical energy or electrical energy can be extended to any type of wind engine as long as having a suitable design. As a result, the wind energy harvesting efficiency of the wind engine can reach ˜80% which is ˜10 times higher than that of a traditional overhead wind engine solution of the same power.

Sixth, adjusting the wind-catch direction according to the wind direction only needs to be done for the light-weight overhead wind catcher, so using just a tail vane attached to the wind catcher would be much simpler than having to rotate a traditional overhead wind engine weighted hundreds of tons. Even installing an additional automatic yaw system for the wind catcher's 360-degree rotation towards the wind direction would also be much simpler.

Seventh, regarding the environmental issue, because the wind engine is encompassed in a soundproof structure on the ground, the noise is significantly overcome. In addition, since the blades of the wind engine in the form of the air turbine are made of metal, they can be recycled when the life span ends up.

### BRIEF DESCRIPTION OF THE DRAWINGS

The purposes, advantages and other aspects of the present invention will become obvious in the following detailed description with the reference to the accompanying drawings, where:

FIG. 1 shows a typical overhead horizontal axis wind engine with 3 blades attached to a nacelle at their back side.

FIG. 2 depicts a wind duct with a cross section that varies according to Betz's conditions.

FIGS. 3a-3d show the movement of the airflow through the blades of the wind engine in two different states and the diagrams for analyzing wind pressures applied on the blades.

FIGS. 4a-4c are 3D images showing a specific example of a wind catcher 1 with a tail vane 2 and a windbreak cover 4.

FIG. 5a depicts a cross-section of a proposed air turbine and FIG. 5b is a picture of a steam turbine model that can be modified to be that air turbine.

FIG. 6a depicts an overall arrangement diagram of an equipment system for indirectly catching wind used in the overhead wind energy harvesting method, wherein an air turbine 11 is arranged in the vertical direction, while FIGS. 6b and 6c are the front view and the lateral view, respectively, of the equipment system having the arrangement shown in FIG. 6a.

FIG. 7a depicts the overall arrangement diagram of another equipment system for indirectly catching wind used in the overhead wind energy harvesting method, wherein the air turbine 11 is arranged in the horizontal direction and the equipment system further comprise a vertical axis wind engine 15, while FIGS. 7b and 7c are the front view and the lateral view, respectively, of the equipment system having the arrangement shown in FIG. 7a.

FIG. 8a and FIG. 8b are the front view and the lateral view, respectively, of the equipment system substantially same as those in FIG. 7, but further provided with a vertical axis wind engine 17 arranged in horizontal direction in front of the wind deflector elbow 14.

FIG. 9a and FIG. 9b are the front view and the lateral view, respectively, of the equipment system substantially same as those in FIG. 6, but the air turbine 11 that arranged in the vertical direction is replaced with an air turbine 20 within which the air flows in a circular direction in a manner similar to the principle of hydraulic turbines used in hydroelectricity.

### DETAILED DESCRIPTION OF THE INVENTION

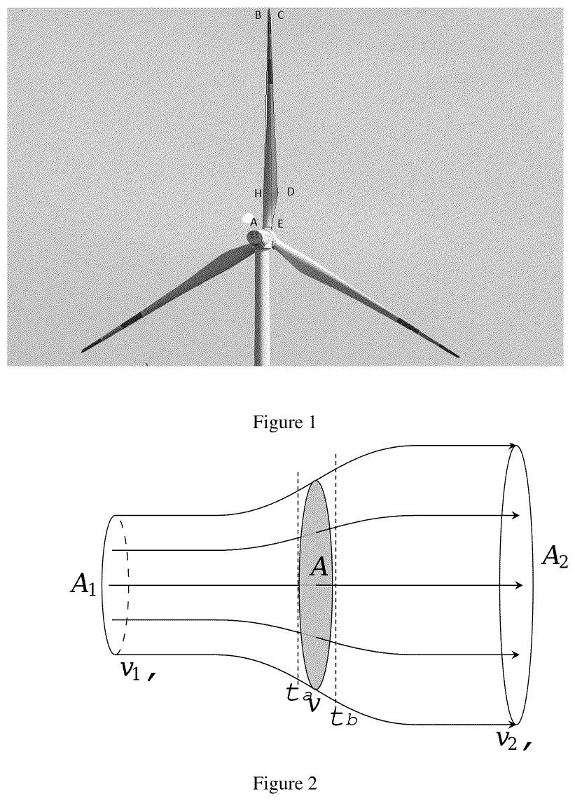

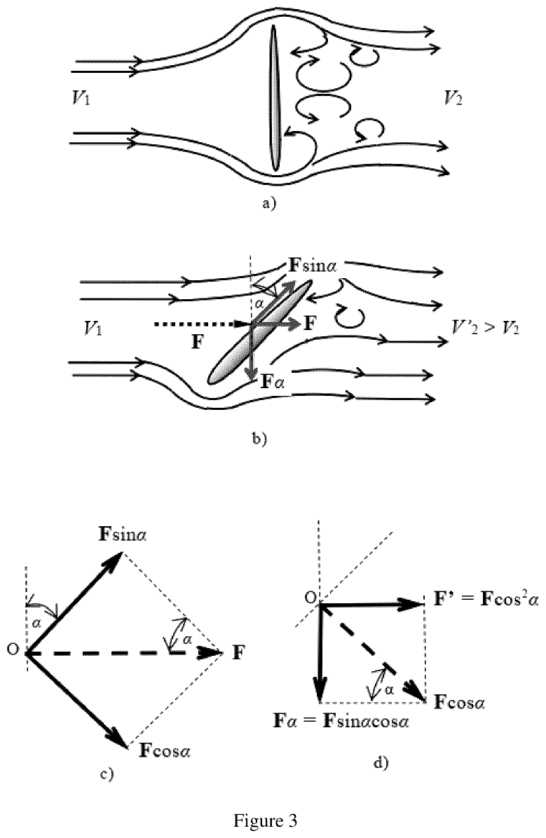

Next will be a detailed description of the method of harvesting overhead wind energy based on the accompanying FIGS. 1-9.

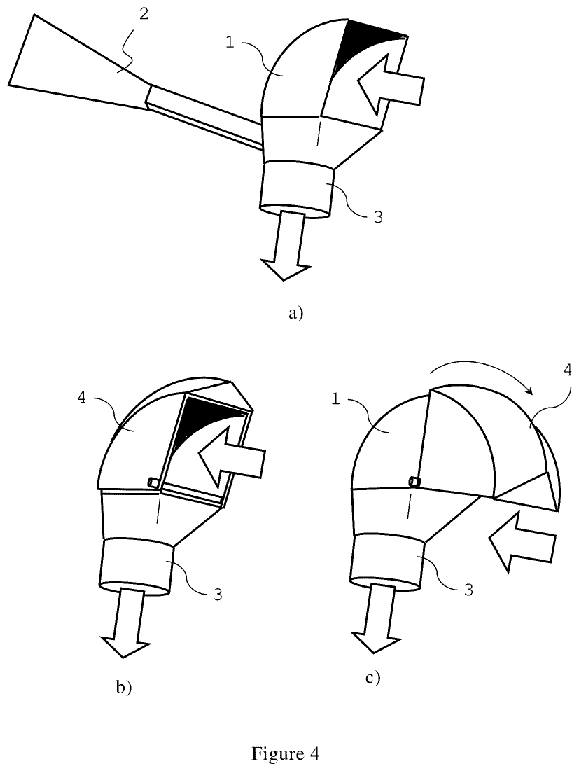

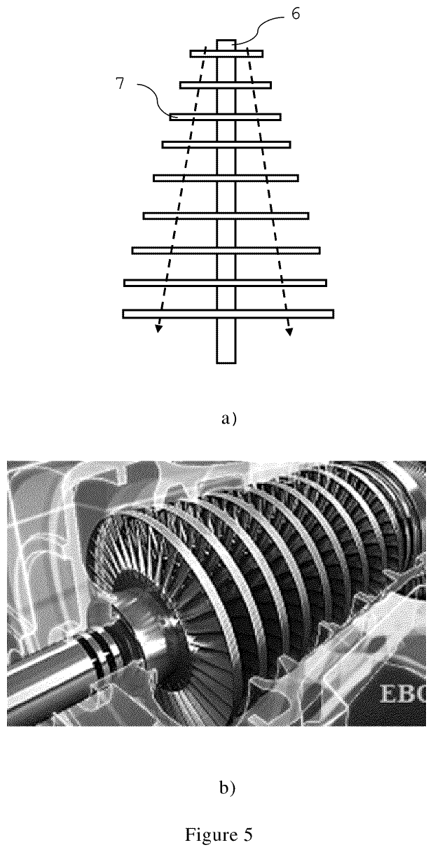

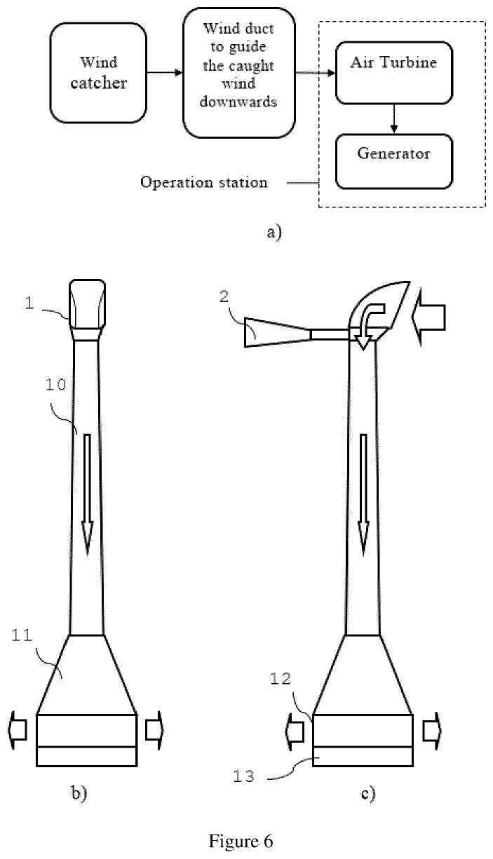

As mentioned above, the blades of the overhead wind engine have been designed to be longer and longer to increase the wind-catch power. The longer the blades are, the higher the wind engine must be arranged, this makes the structure increasingly cumbersome and heavier, while the blade's wind-catch efficiency η_{CQ} is just under 5%. Therefore, to overcome the disadvantages of the prior art, the present invention provides a method of harvesting overhead wind energy with an equipment system for indirectly catching wind, that is, the wind is caught and guided downwards along the wind duct, then the energy of the caught wind is converted by the wind engine to mechanical work to rotate one or more generators. In an embodiment, the equipment system for indirectly catching wind used in the overhead wind energy harvesting method is schematically presented in FIG. 6a, and detailedly presented in FIG. 4, FIG. 6b and FIG. 6c, the equipment system includes:
an overhead wind catcher 1 with a flare inlet and a narrow outlet 3 to increase the velocity of the wind caught and guided downwards;
a tail vane 2 attached to the overhead wind catcher 1 to orientate the latter towards the wind direction;
a windbreak cover 4;
a wind duct 10 to guide the caught wind downwards;
a high efficiency air turbine 11 arranged in vertical direction; an air exit chamber 12; and
an operation station 13 on the ground to encompass all parts of the wind engine and other auxiliary structures.

Here, the wind catcher with the cross section S_{Ch} which is only equivalent to the total dynamic wind-catch cross section ns_{α} imparts a rotating torque of being exactly equal to η_{CQ}S to the blades, i.e. its power is just equivalent to only ⅓ to 1/2.5 of the power value announced by wind engine manufacturers. However, the commercial electrical production remains unchanged because the commercial electricity generation time, which is correctly assessed according to the actual windy time in the year, is greater than 2.5 to 3 times. This assures that the project is still profitable in practice.

To reduce the size of the components to be assembled with the wind catcher 1, it is possible to structurally calculate the wind catcher 1 so that its outlet wind velocity is N times greater than the inlet wind velocity. Through the wind duct 10 with the cross section S_{OD} S_{Ch}/N, the wind energy is now guided downwards to the ground to run the air turbine 11 located there. Because the wind has been concentrated into a flow within the wind duct, the wind engine can be of any type provided that it could have the highest efficiency (i.e. over 80%) and not necessarily be the horizontal axis wind engine (of which the efficiency is only <5%) to withstand the windstorm. The air exit chamber 12 is calculated so as to have the minimal aerodynamic resistance and the minimal loss, and to be suitable with the installation site.

In this embodiment, because the air turbine 11 is arranged in the vertical direction, the structure is relatively compact, taking up less space, but in return, it is more difficult for manufacturing and maintenance.

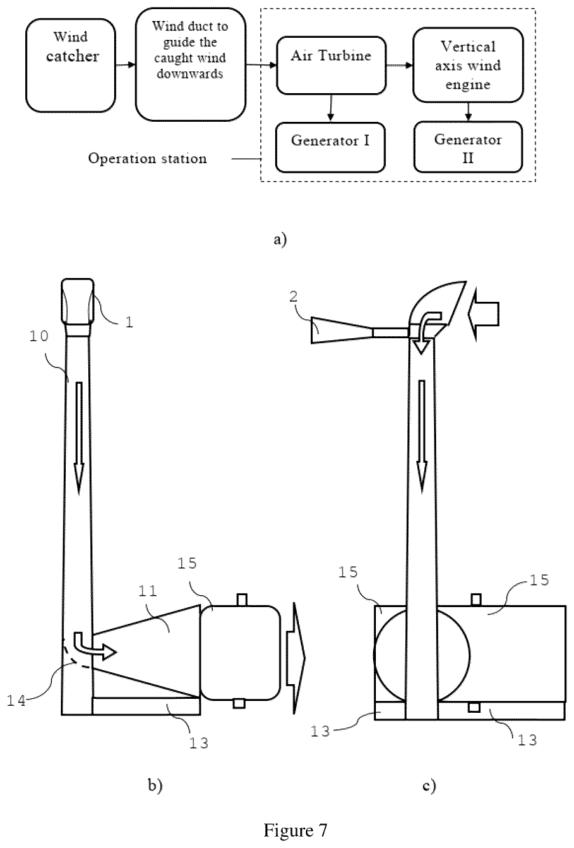

In another aspect, to overcome the above disadvantages, it is possible to arrange the air turbine 11 in the horizontal direction as shown in FIGS. 7b and 7c. At this point, a wind deflector elbow 14 is required, and the air exit chamber 12 is no longer needed as the wind has already self-exited in a specified direction. Therefore, a vertical axis wind engine 15 with a high efficiency ˜80% can be further provided right behind the air turbine 11 having the oriented wind to take advantage of the energy of low velocity wind after passing through the said air turbine to run the generator II according to the diagram in FIG. 7a.

At this time, the presence of the wind deflector elbow 14 causes an energy loss of the wind entering the air turbine 11.

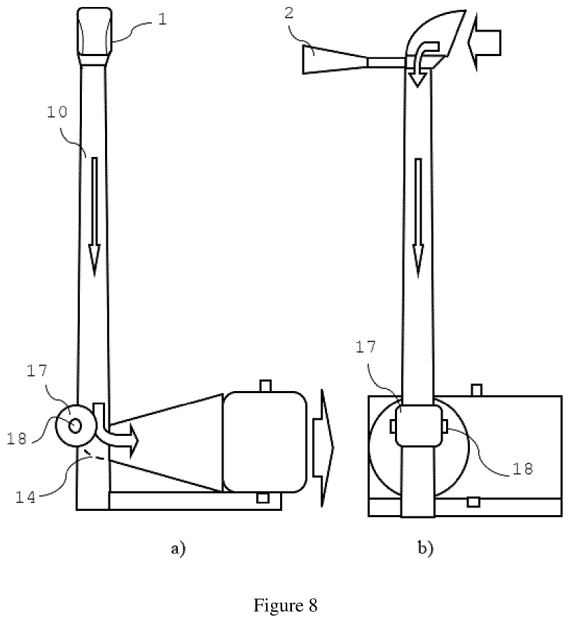

In another aspect, to overcome this situation, it is possible to have an additional wind engine of the vertical axis principle 17 but being arranged in the horizontal direction on an axis 18, just above the wind deflector elbow 14 as shown in FIGS. 8a and 8b. At that time, it will be necessary to connect up to three generators, making the structure complicated.

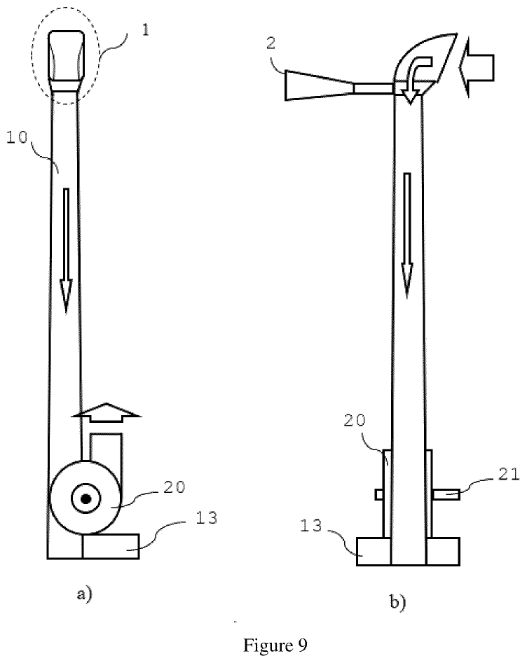

In another aspect, to overcome this shortcoming, it is possible to simply use an air turbine 20 having a shaft 21, within which the air flows in a circular direction in a manner similar to the principle of hydraulic turbines used in hydroelectricity as shown in FIGS. 9a and 9b. Here, since the air flows along a circular arc path, the time for the energy exchange with the turbine blades is prolonged.

### Effect of the Invention

The method of harvesting overhead wind energy according to the present invention comes from a more accurate determination of the wind engine efficiency which is very low and therefore allows the implementation of an equipment system for indirectly catching wind, rather than directly installing overhead equipments. This helps to greatly reduce the costs of overhead wind engine including the transportation, installation and maintenance costs.

Although the invention has been described in detail for several implementations, it is important for a person skilled in the art to understand that various modifications can be made that are not outside the scope of the invention's protection.

1. A method of harvesting overhead wind energy with an equipment system for indirectly catching wind, the method comprises:
catching overhead wind;
guiding the caught overhead wind downwards;
converting the energy of the caught wind into mechanical work to rotate one or more generators,
wherein the equipment system for indirectly catching wind comprises:
an overhead wind catcher (1) with a flare inlet and a narrow outlet (3) to increase the velocity of the wind caught and guided downwards;
a tail vane (2) attached to the overhead wind catcher (1) to orientate the latter towards the wind direction;
a windbreak cover (4);
a wind duct (10) to guide the caught wind downwards;
a high efficiency air turbine;
optionally an air exit chamber (12); and
an operation station (13) on the ground to encompass all parts of the wind engine and other auxiliary structures.

2. The method according to claim 1, wherein the high efficient air turbine is an air turbine (11) arranged in the vertical direction, and the air exit chamber (12) is present.

3. The method according to claim 1, wherein the air turbine is an air turbine (11) arranged in the horizontal direction, the equipment system further comprises a wind deflector elbow (14) and the air exit chamber (12) is removed so that the wind can self-exit in a specified direction, the equipment system also further comprises a vertical axis wind engine (15) with a high efficiency ˜80% arranged right behind the air turbine (11) to take advantage of the energy of low velocity wind.

4. The method according to claim 3, wherein the equipment system further comprises an additional wind engine of the vertical axis principle (17) but being arranged in the horizontal direction on an axis (18), just above the wind deflector elbow (14).

5. The method according to claim 1, wherein the air exit chamber (12) is absent, and the high efficient air turbine is a flat blade air turbine (20) having a shaft (21) working in a manner similar to the principle of hydraulic turbines used in hydroelectricity to prolong the time for exchanging the energy with the turbine blades.
